(19) United States
(12) Patent Application Publication
(10) Pub. No.: US 2015/0003473 A1
(43) Pub. Date: Jan. 1, 2015

(54) MACHINE-TO-MACHINE (M2M) SERVER AND DATA PROCESSING METHOD THEREOF

(71) Applicant: SAMSUNG ELECTRO-MECHANICS CO., LTD., Suwon (KR)

(72) Inventors: Jae Hee PARK, Suwon (KR); Dae Yeol SEO, Suwon (KR); Kyung Ah CHO, Suwon (KR)

(73) Assignee: SAMSUNG ELECTRO-MECHANICS CO., LTD., Suwon (KR)

(21) Appl. No.: 14/029,125

(22) Filed: Sep. 17, 2013

(30) Foreign Application Priority Data
Jun. 28, 2013 (KR) 10-2013-0076060

(51) Int. Cl. H04L 1/00; H04W 4/00

(52) U.S. Cl. CPC H04L 1/0006; H04W 4/006
USPC 370/474; 370/476

(57) ABSTRACT

There are provided a machine-to-machine (M2M) server and a data processing method thereof. The M2M server includes: a receiving unit receiving a plurality of pieces of sensor data from a plurality of M2M devices; a combining unit combining the plurality of pieces of sensor data transferred from a receiving unit with each other according to a preset profile; and a transmitting unit transmitting the combined pieces of sensor data.

### CROSS-REFERENCE TO RELATED APPLICATIONS

This application claims the priority of Korean Patent Application No. 10-2013-0076060 filed on Jun. 28, 2013, in the Korean Intellectual Property Office, the disclosure of which is incorporated herein by reference.

### BACKGROUND OF THE INVENTION

1. Field of the Invention

The present invention relates to a machine-to-machine (M2M) server capable of being applied to an M2M communications scheme, and a data processing method thereof.

2. Description of the Related Art

Machine-to-machine (M2M) communications is a technology of adding a sensor communications function to devices to allow for the intelligent collection of information and the transfer of information between devices. In addition to the term machine-to-machine (M2M), such a device-to-device communications scheme is also known as machine type communications (MTC), the internet of things (IoT), the web of things (WoT), or the like, according to standardization organizations.

It is expected that fifty billion or more devices, an amount of devices corresponding to 10 times that of the world's population, 7.1 billion human beings, will be connected to the Internet by 2020, which means that an internet of things (IoT) will be formed. In this case, a core technology will be M2M. M2M may be defined based on converged information and communications technology (ICT), allowing for safe and convenient person-to-person or thing-to-thing intelligent communications services in real time, anytime and anywhere. A basic concept of M2M has already existed in the form of the early stages of mobile communications networks. However, recently, in accordance with the spread of the mobile internet, due to the increasing amount of smartphones in use, interest in M2M has rapidly increased. An M2M platform is configured of three elements, that is, an M2M-enabled device obtaining or generating information regarding another device by a sensor, a wireless communications network transferring the information, and an M2M server processing and utilizing collected information.

Currently, M2M technology is being used in various fields such as streetlamp remote control, bridge/dam safety management, factory/facility management, and the like, in industrial sites such as delivery service delivery tracking, in automated teller machines (ATMs), navigation, and the like, in addition to a radio frequency identification (RFID) type transportation card and a bar code for reading price information in a convenience store.

Standardization organizations have conducted studies and have worked to create software standard interfaces to be applied to respective applications. However, studies into and work on creating software standard interfaces applied to various applications are not sufficient. That is, technology for applying sensor and M2M devices used in a specific field to a new field is required.

### SUMMARY OF THE INVENTION

An aspect of the present invention provides a machine-to-machine (M2M) server capable of generating various pieces of M2M information by processing a plurality of pieces of sensor data based on a single piece of software, and a data processing method thereof.

According to an aspect of the present invention, there is provided an M2M server including: a receiving unit receiving a plurality of pieces of sensor data from a plurality of M2M devices; a combining unit combining the plurality of pieces of sensor data transferred from a receiving unit with each other according to a preset profile; and a transmitting unit transmitting the combined pieces of sensor data.

The combining unit may selectively combine the plurality of pieces of sensor data with each other according to the profile.

The combining unit may add data identification packets to, and combine the data identification packets with, a plurality of pieces of sensor data selected according to the profile among the plurality of pieces of sensor data.

The combining unit may add header information, according to the profile, to the sensor data combined according to the profile among the plurality of pieces of sensor data.

The M2M server may further include a storing unit storing the plurality of pieces of sensor data received by the receiving unit, wherein the combining unit combines the plurality of pieces of sensor data stored in the storing unit with each other according to the profile.

The M2M server may further include a profile setting unit storing a plurality of profiles, wherein at least one of the plurality of profiles is provided to the combining unit.

The receiving unit and the plurality of M2M devices may communicate with each other by at least one of long term evolution (LTE), wideband code division multiple access (WCDMA), code division multiple access (CDMA), general packet radio service (GPRS), wireless-fidelity (Wi-Fi), Bluetooth, and Zigbee.

The transmitting unit may transmit the combined pieces of sensor data by an application programming interface (API).

According to another aspect of the present invention, there is provided a data processing method of an M2M server, including: receiving a plurality of pieces of sensor data from a plurality of M2M devices; combining the plurality of pieces of sensor data with each other according to a preset profile; and transmitting the combined pieces of sensor data.

The combining may include: selecting the plurality of pieces of sensor data according to the profile; adding data identification packets to, and combining the data identification packets with, the plurality of selected pieces of sensor data; and adding header information according to the profile to the combined pieces of sensor data.

The data processing method may further include storing the plurality of received pieces of sensor data.

In the receiving, the plurality of pieces of sensor data maybe received by performing communications with the plurality of M2M devices by at least one of long term evolution (LTE), wideband code division multiple access (WCDMA), code division multiple access (CDMA), general packet radio service (GPRS), wireless-fidelity (Wi-Fi), Bluetooth, and Zigbee.

In the transmitting, the combined pieces of sensor data may be transmitted by an application programming interface (API).

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a configuration diagram of a machine-to-machine (M2M) system according to an embodiment of the present invention;

FIGS. 2 and 3 are block diagrams showing an M2M server according to the embodiment of the present invention;

FIGS. 4 and 5 are diagrams showing an example of data output from a combining unit, a component according to the embodiment of the present invention; and

FIGS. 6 and 7 are diagrams for describing a data processing method of an M2M server according to the embodiment of the present invention.

### DETAILED DESCRIPTION OF THE EMBODIMENTS

Hereinafter, embodiments of the present invention will be described in detail. The invention may, however, be embodied in many different forms and should not be construed as being limited to the embodiments set forth herein. Rather, these embodiments are provided so that this disclosure will be thorough and complete, and will fully convey the scope of the invention to those skilled in the art. Throughout the drawings, the same or like reference numerals will be used to designate the same or like elements.

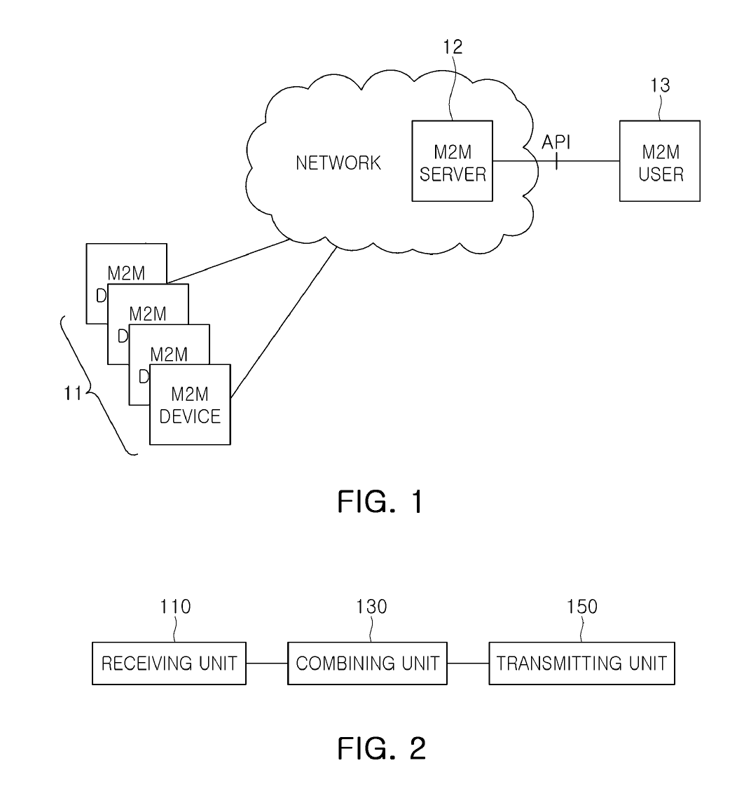

FIG. 1 is a configuration diagram of a machine-to-machine (M2M) system according to an embodiment of the present invention. As shown in FIG. 1, the M2M system may include a plurality of M2M devices 11, an M2M server 12, and an M2M user 13.

The M2M device 11 may be a terminal having an M2M function of communicating with the M2M server 12 and other M2M devices through a public land mobile network (PLMN). The M2M server 12 may communicate with the PLMN and communicate with the M2M devices 11 through the PLMN. Further, the M2M server 12 may also have an interface accessible by the M2M user 13 and provide a service for the M2M user 13. The M2M user 13 may use the service provided by the M2M server 12. In the configuration of FIG. 1, the M2M server 12 may be controlled by a network operator providing an application programming interface (API) on the M2M server, and the M2M user 13 may access the M2M server of the network operator through the API. Although the configuration in which the M2M server is included inside a network operator domain has been shown in FIG. 1, the M2M server is not positioned inside the network operator domain, but may also be positioned outside of the network operator domain. In this case, the M2M server is not controlled by the network operator.

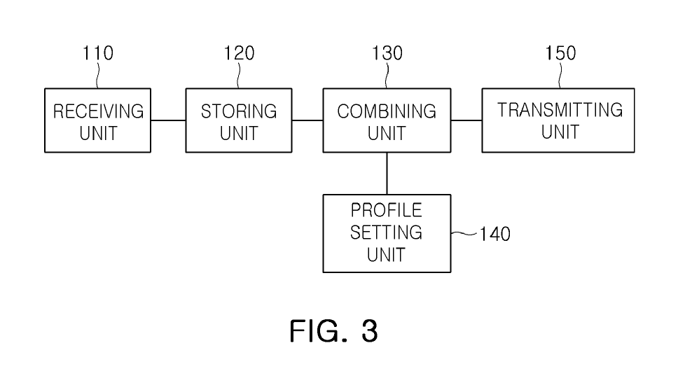

FIGS. 2 and 3 are block diagrams showing an M2M server according to the embodiment of the present invention. Referring to FIG. 2, the M2M server according to the present embodiment may include a receiving unit 110, a combining unit 130, and a transmitting unit 150. Referring to FIG. 3, the M2M server according to the present embodiment may further include a storing unit 120 and a profile setting unit 140.

The receiving unit 110 may communicate with various M2M devices. The receiving unit 110 may receive sensor data from the M2M devices using long term evolution (LTE), wideband code division multiple access (WCDMA), code division multiple access (CDMA), general packet radio service (GPRS), wireless-fidelity (Wi-Fi), Bluetooth, or Zigbee communications.

The storing unit 120 may store a plurality of pieces of sensor data received by the receiving unit 110. The plurality of pieces of sensor data stored in the storing unit 120 may be provided to the combining unit 130. In this case, the same kind of sensor data stored several times may be updated before being provided to the combining unit 130.

The combining unit 130 may combine the plurality of pieces of sensor data transmitted from the various M2M devices with each other according to a preset profile. Here, the profile indicates a scenario for processing various pieces of sensor data into data required by a server system. The profile setting unit 140 may have a plurality of profiles stored therein, at least one of the plurality of profiles may be set by user selection, and the set profile may be provided to the combining unit 130.

For example, it is assumed that a current state, a power state, a power use amount, a position (GPS) information, a product sale amount, tire air pressure information, battery information, temperature information, and the like, are received by the receiving unit 110 and the profile selected among the plurality of profiles stored in the profile setting unit 140 is a profile applied to a smart metering application. The combining unit 130 may combine plurality of pieces of sensor data regarding the current state, the power state, and the power use amount with each other according to the profile applied to the smart metering application.

In this case, the combining unit 130 may selectively combine the plurality of pieces of sensor data regarding the current state, the power state, and the power use amount with each other according to the profile applied to the smart metering application. The kinds of profiles applied to the above-mentioned smart metering application are not limited to one, but may be provided in plural. For example, there may be a profile only set by the current state, a profile set by the current and voltage states, a profile set by the current and voltage states and the power use amount, and the like, and the plurality of pieces of sensor data maybe selectively combined with each other according to the set profile.

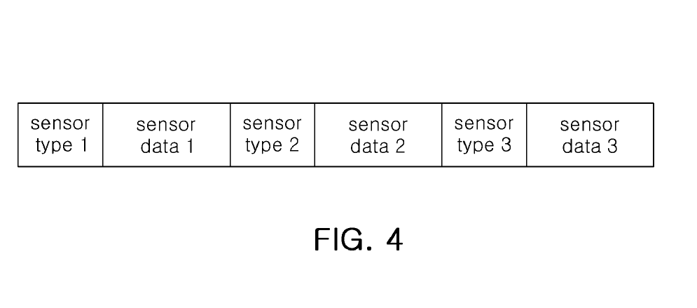

In addition, the combining unit 130 may add data identification packets about sensor types when it combines the plurality of pieces of sensor data with each other. For example, when it is assumed that the profile set by the current and voltage states and the power use amount is selected, referring to FIG. 4, it could be confirmed that data identification packets such as sensor type 1, sensor type 2, and sensor type 3 are added in addition to sensor data 1 corresponding to current sensor data, sensor data 2 corresponding to voltage sensor data, and sensor data 3 corresponding to power use amount sensor data.

Further, the combining unit 130 may add header information to a profile as well as the data identification packets about the sensor type when it combines the plurality of pieces of sensor data with each other. For example, when it is assumed that the profile set by the current and voltage states and the power use amount is set to profile 2, it could be confirmed in FIG. 4 that header information on the profile 2 is added to the combined plurality of pieces of sensor data (payload).

The data identification packets about the sensor types and the header information on the profile are added to the combined plurality of pieces of sensor data to allow the combined plurality of pieces of sensor data to be more easily recognized, whereby a data processing time may be decreased.

The transmitting unit 150 may receive the sensor data combined by the combining unit 130 and transfer the received combined pieces of sensor data to the user, or the like, through the application programming interface (API).

According to the embodiment of the present invention, the plurality of pieces of sensor data transferred from various types of M2M devices are combined with each other and are processed according to the profile set by user determination, whereby various pieces of data required by the M2M user may be generated using one piece of software and one type of hardware.

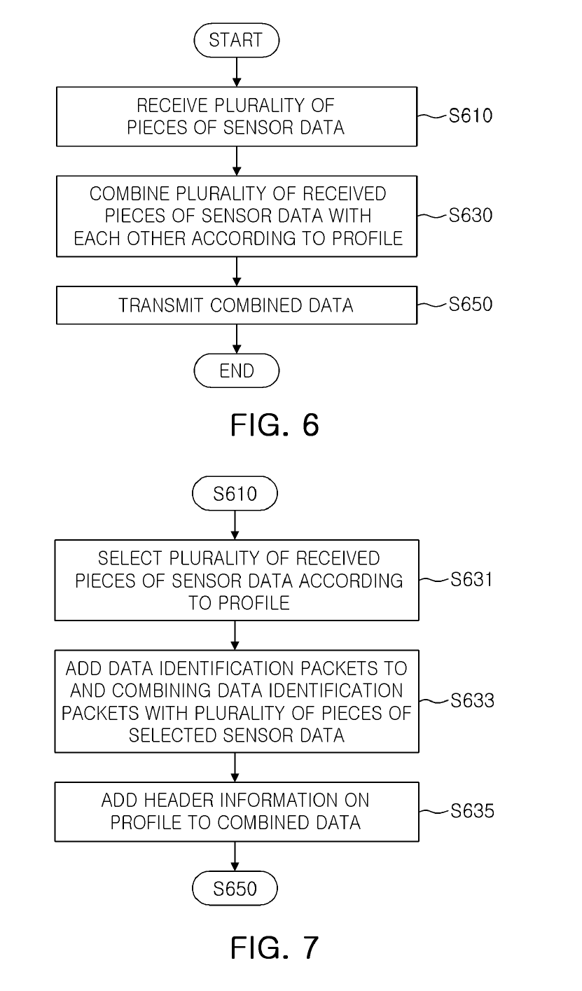

FIG. 6 is a flow chart showing a data processing method according to the embodiment of the present invention. The data processing method according to the present embodiment will be described with reference to FIGS. 3 and 6.

The receiving unit 110 receives the plurality of pieces of sensor data transmitted from various M2M devices (S610). In operation (S610), the receiving unit 110 may receive plurality of pieces of sensor data sensed by the M2M devices using long term evolution (LTE), wideband code division multiple access (WCDMA), code division multiple access (CDMA), general packet radio service (GPRS), wireless-fidelity (Wi-Fi), Bluetooth, or Zigbee communications.

The plurality of pieces of sensor data received by the receiving unit 110 may be combined with each other by the combining unit 130 (S630). Here, the profile indicates a scenario for processing various pieces of sensor data into data required by a server system. Here, the profile setting unit 140 may have a plurality of profiles stored therein, at least one of the plurality of profiles may be set by user selection, and the combining unit 130 may combine the plurality of pieces of sensor data with each other according to the set profile.

For example, in operation (S610), it is assumed that the receiving unit 110 receives a current state, a power state, a power use amount, position (GPS) information, a product sale amount, tire air pressure information, battery information, temperature information, and the like, and the profile selected among the plurality of profiles stored in the profile setting unit 140 is the profile applied to the smart metering application. In operation (S630), the sensor data regarding the current state, the power state, and the power use amount may be combined with each other according to the profile applied to the smart metering application.

The plurality of pieces of sensor data combined in operation (S630) may be transferred to the transmitting unit 150, and the transmitting unit 150 may transmit the combined pieces of sensor data to a data processing circuit, or the like, for processing the combined pieces of sensor data.

FIG. 7 is a flow chart showing a data combining operation according to the embodiment of the present invention in detail. The data combining operation will be described with reference to FIGS. 2 and 7.

The plurality of pieces of sensor data received in operation (S610) and transferred to the combining unit 130 may be selected according to the profile (S631). For example, when it is assumed that the current state, the power state, the power use amount, the position (GPS) information, the product sale amount, the tire air pressure information, the battery information, the temperature information, and the like, are transferred to the combining unit 130 and the profile applied to the smart metering application is set by the combining unit 130, at least one of the sensor data regarding the current state, the power state, the power use amount may be selected.

The kinds of profiles applied to the above-mentioned smart metering application are not limited to one, but may be provided in plural. More specifically, there may be a profile set only by the current state, a profile set by the current and voltage states, a profile set by the current and voltage states and the power use amount, and the like. In operation (S631), the plurality of pieces of sensor data may be selected according to the set profile.

The plurality of pieces of sensor data selected in operation (S631) may be combined with each other by themselves. However, when the plurality of pieces of sensor data are combined with each other, data identification packets about sensor types may be added to and combined with the plurality of pieces of sensor data (S633). For example, when it is assumed that the profile in which the current and voltage states and the power use amount are selected and combined with each other is selected, referring to FIG. 4, it could be confirmed that data identification packets such as sensor type 1, sensor type 2, and sensor type 3 are added to front ends of the respective sensor data packets in addition to sensor data 1 corresponding to current sensor data, sensor data 2 corresponding to voltage sensor data, and sensor data 3 corresponding to power use amount sensor data.

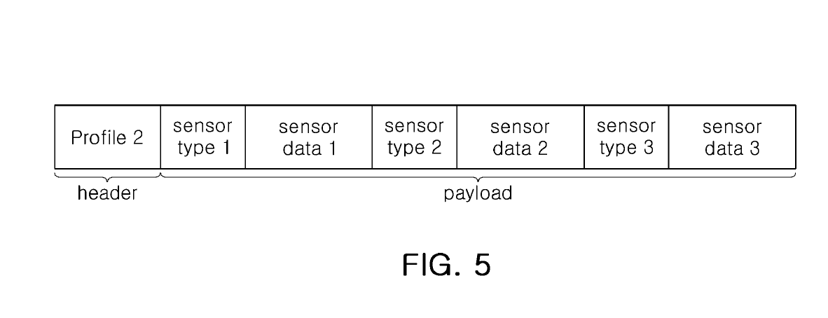

In operation (S633), header information on the profile may be further added to the combined pieces of sensor data. For example, when it is assumed that the profile in which the current and voltage states and the power use amount are selected and combined with each other is set to profile 2, it could be confirmed in FIG. 5 that header information on the profile 2 is added to the combined pieces of sensor data (payload).

As set forth above, according to the embodiment of the present invention, the plurality of pieces of sensor data are combined with each other according to the preset profile, whereby various M2M information may be generated.

While the present invention has been shown and described in connection with the embodiments, it will be apparent to those skilled in the art that modifications and variations can be made without departing from the spirit and scope of the invention as defined by the appended claims.

What is claimed is:

1. A machine-to-machine (M2M) server comprising:
a receiving unit receiving a plurality of pieces of sensor data from a plurality of M2M devices;
a combining unit combining the plurality of pieces of sensor data transferred from a receiving unit with each other according to a preset profile; and
a transmitting unit transmitting the combined pieces of sensor data.

2. The M2M server of claim 1, wherein the combining unit selectively combines the plurality of pieces of sensor data with each other according to the profile.

3. The M2M server of claim 2, wherein the combining unit adds data identification packets to, and combines the data identification packets with, a plurality of pieces of sensor data selected according to the profile among the plurality of pieces of sensor data.

4. The M2M server of claim 1, wherein the combining unit adds header information, according to the profile, to the sensor data combined according to the profile among the plurality of pieces of sensor data.

5. The M2M server of claim 1, further comprising a storing unit storing the plurality of pieces of sensor data received by the receiving unit,
wherein the combining unit combines the plurality of pieces of sensor data stored in the storing unit with each other according to the profile.

6. The M2M server of claim 1, further comprising a profile setting unit storing a plurality of profiles,
wherein at least one of the plurality of profiles is provided to the combining unit.

7. The M2M server of claim 1, wherein the receiving unit and the plurality of M2M devices communicate with each other by at least one of long term evolution (LTE), wideband code division multiple access (WCDMA), code division multiple access (CDMA), general packet radio service (GPRS), wireless-fidelity (Wi-Fi), Bluetooth, and Zigbee.

8. The M2M server of claim 1, wherein the transmitting unit transmits the combined pieces of sensor data by an application programming interface (API).

9. A data processing method of an M2M server, comprising:
receiving a plurality of pieces of sensor data from a plurality of M2M devices;
combining the plurality of pieces of sensor data with each other according to a preset profile; and
transmitting the combined pieces of sensor data.

10. The data processing method of claim 9, wherein the combining includes:
selecting the plurality of pieces of sensor data according to the profile;
adding data identification packets to, and combining the data identification packets with, the plurality of selected pieces of sensor data; and
adding header information according to the profile to the combined pieces of sensor data.

11. The data processing method of claim 9, further comprising storing the plurality of received pieces of sensor data.

12. The data processing method of claim 9, wherein in the receiving, the plurality of pieces of sensor data are received by performing communications with the plurality of M2M devices by at least one of long term evolution (LTE), wideband code division multiple access (WCDMA), code division multiple access (CDMA), general packet radio service (GPRS), wireless-fidelity (Wi-Fi), Bluetooth, and Zigbee.

13. The data processing method of claim 9, wherein in the transmitting, the combined pieces of sensor data are transmitted by an application programming interface (API).
